(19) United States
(12) Patent Application Publication
(10) Pub. No.: US 2013/0071518 A1
(43) Pub. Date: Mar. 21, 2013

(54) METHOD FOR PRODUCING MEAT PRODUCTS AND MEAT PRODUCT PRODUCED BY SAID METHOD

(71) Applicant: Rolf Haussler, Boblingen (DE)

(72) Inventor: Rolf Haussler, Boblingen (DE)

(73) Assignee: VAN HEES GMBH, Walluf (DE)

(21) Appl. No.: 13/700,130

(22) PCT Filed: Nov. 3, 2011
(86) PCT No.: PCT/EP11/69292

§ 371 Date: Nov. 26, 2012

(30) Foreign Application Priority Data
Nov. 4, 2010 (DE) 102010050466.1

(51) Int. Cl. A23L 1/314

(52) U.S. Cl. CPC A23L 1/314
USPC 426/7; 426/641

(57) ABSTRACT

The present invention relates to a method for producing meat products, in particular sausage, on the basis of substantially known recipes and basic principles of typical sausage varieties having a shortened ripening time, wherein, during processing, two ripening-accelerating mixtures of stabilizers, colorants and/or edible salts (ripening mixture 1) and spices, flavoring agents and/or thickeners (ripening mixture 2) are introduced simultaneously or successively into the raw meat mixture.

### I. FIELD OF THE INVENTION

The present invention concerns a method for production of meat products, especially sausage based on essentially known recipes and principles of typical sausage products with shortened ripening time, as well as a meat product produced according to this method.

### II. TECHNICAL BACKGROUND

The production of firm meat products is divided into the process steps fermentation, connected with a pH value reduction, and incipient aromatization as well as drying, connected with an a_{w} value reduction and strongly advanced aromatization.

During drying a ripening process occurs, caused by certain bacteria. Since the vitality of many different bacteria depends strongly on the so-called free water in the meat product, stated by the a_{w} value, attempts are made with many different technical means to reach a lower a_{w} value as quickly as possible.

The lower the a_{w} value, the fewer bacteria can live in the meat products, thus preserving it.

For this purpose, a ripening and spice mixture, as well as starter cultures and nitrate (saltpeter) or nitrite as nitrite pickling salt are generally added to the specific meat recipe.

The material produced with the Wolf grinder (passing machine) or Kutter grinder is filled into steam-permeable artificial or natural intestine.

The first process step, fermentation, occurs under controlled climatic conditions in the ripening chamber. The pH value drops and a meat aroma begins to form, especially in raw sausages a raw sausage aroma. In the second process step drying is conducted also under controlled climatic conditions. During drying the a_{w} value drops and aromatization continues strongly.

The total process takes a week or several months, depending on the type and size of the meat product being ripened. Weight losses of about 15 to about 40% and more then occur.

The meat product becomes microbiologically stable through
a) its treatment to reduce the pH value by fermentation or acidification agents and
b) its a_{w} value by drying,
c) addition of preservatives, like nitrate or nitrite, nitrite generally being added as nitrite pickling salt.

A method for production of raw sausage is known from DE 3831229, in which a specific ripening, keeping quality and drying state are produced by water removal by homogeneously incorporating a water-absorbing and water-conducting substance in the sausage, which removes the free water present in the sausage outward in an accelerated manner.

DE 10 2008 038 565 describes a method for accelerated ripening of raw sausages, in which ripening is conducted in a sleeve with a water vapor permeability of less than 600 g/m² at a relative humidity of less than 60%. By the method the ripening time can be reduced to 17.7 days.

EP 1601257 describes a method for production of raw sausages with accelerated ripening process in which folic acid and/or folates are added to the meat mass, while observing a uniform distribution, so that based on natural processes of raw sausage production a rapid rise in the available population of microorganisms of lactic acid-forming micrococci and/or lactobacilli occurs. The ripening process can be reduced to a period of about 21 days through the described method.

### III. SPECIFICATION OF THE INVENTION

a) Technical Object

The object of the invention is therefore to provide a method for production of meat products, especially sausage, in which the ripening times known from the prior art can be extremely reduced without weight loss and without using climatic and ripening chambers.

b) Solution of the Object

This object is achieved by a method for production of meat products, especially sausage, based on essentially known recipes and principles of typical sausage types, wherein, during processing two mixtures that accelerate ripening from stabilizers, colorants and/or edible salts (ripening mixture 1) and from spices, flavorings and/or thickeners (ripening mixture 2) are added simultaneously or successively into the raw meat mass.

This makes it possible for both the pH value and the a_{w} value of the end products to be reduced and imparts a certain aromatization to the meat product deriving thereof.

In addition, the use of otherwise common climatic and ripening chambers is no longer required by the method according to the invention.

Depending on the type of treatment (Kutter or Wolf grinding) the mixtures that accelerate ripening can be introduced to the raw meat mass simultaneously or successively so that excessive cooling and other steps are no longer necessary.

The terms meat mass and raw meat mass are used subsequently as synonyms and include both raw and/or processed and/or frozen meat, as well as mixtures of meat and bacon or speck.

It has been shown according to the invention that the ripening mixtures 1 and 2 that accelerate ripening are added in amounts from 0.1 to 4.0% by weight, based on the total weight of the raw meat mass. Taste or appearance of the meat mass can be positively influenced in this case after corresponding processing in terms of color and appearance.

A positive effect on pH value, a_{w} value and texture also occurs.

It has been shown to be sufficient for the invention that the stabilizers, colorants and/or edible salts contained in ripening mixture 1 are contained in an amount from 0.2 to 1.5%, by weights preferably 0.3 to 0.7% by weight stabilizers, especially 0.5% by weight stabilizers, colorants, especially commercially available colorants under the name “Colorant® intensiv”, commercially available from VAN HEES GmbH, in an amount from 0.1 to 0.5% by weight, preferably 0.15 to 0.4% by weight, especially preference 0.25% by weight colorant, as well as 0.05 to 0.5% by weight, preferably 0.01 to 0.3% by weight, especially 0.1% by weight edible salt.

The ripening mixture 1 preferably contains 0.45 to 1.6% by weight of the aforementioned stabilizers, colorants and edible salts, preferably 0.6 to 1.3% by weight, especially 0.85% by weight.

It has proven advantageous in order to shorten the ripening time of the meat products to also use a ripening mixture 2 in addition to the aforementioned ripening mixture 1, wherein ripening mixture 2 essentially consists of spices, flavorings and thickeners.

According to the invention the use of 0.1 to 0.7% by weight, preferably 1.5 to 0.6% by weight, especially 0.3 to 0.4% by weight ground black pepper, 1.0 to 2.5% by weight, preferably 1.5 to 2.0% by weight, especially 1.8% by weight commercially available minor hot mustard flour, 0.05 to 0.6% by weight, preferably 0.1 to 0.5% by weight, especially 0.25 to 0.35% by weight commercially available licorice root powder, 0.01 to 0.05% by weight, especially 0.03 to 0.04% by weight commercially available Chorizo Aroma Powder 315487 and 0.1 to 0.9% by weight, preferably 0.2 to 0.7% by weight, especially 0.4 to 0.5% by weight thickener, preferably commercially available RMB650 alginate 115841 from the Cargill Co., has proven suitable. The % by weight then refers to the total weight of the raw meat mass.

Overall, the preferred use range according to the invention of ripening mixture 2 of spices, flavorings and thickeners should be on the order of 2.0 to 4.0% by weight, preferably 2.4 to 3.8% by weight, especially 3.0% by weight, based on the total weight of the raw meat mass.

To impart a better taste and to prevent oxidation or accelerate the ripening process it has proven advantageous according to the invention to use additional additives, like spices, acidifying agents, enzymes, salts and/or microorganisms as starter and/or protective cultures.

The commercially available spices AROMIX® garlic 333045 from VAN HEES GmbH, PRIMAL® Rapid 103611 from VAN HEES GmbH as acidifier, the transglutaminase commercially available from VAN HEES GmbH under the name Brat Stabil®, and as protective culture the commercially available PRIMAL® Protect K101478 from VAN HEES GmbH have proven promising as appropriate additional additives for the invention. Nitrite pickling salt (NPS), which is an edible salt with preservatives and is commercially available, is added to the raw meat mass as additional additive to influence the taste and a_{w} value.

Advantageously used amounts of the aforementioned additives according to the invention are on the order from 0.05 to 5.0% by weight, preferably 0.1 to 4.0% by weight, especially 0.15 to 3.0% by weight, based on the total weight of the raw meat mass.

Depending on the intended purpose, use of these additional additives in different intensity is provided, in which case the spice AROMIX® garlic 333045 is used between 0.1 to 0.4% by weight, preferably around 0.2% by weight, the acidifier PRIMAL® Rapid 103611 is used in an amount of about 0.5 to 2.0% by weight, preferably 0.9 to 1.8% by weight and especially 1.2 to 1.4% by weight, based on the total weight of the raw meat mass.

Enzymes like the aforementioned Brat Stabiles are generally used in an amount from 0.1 to 0.5% by weight, preferably 0.2 to 0.4% by weight, especially 0.25% by weight, based on the total weight of the raw meat mass.

The situation is comparable with the starter and/or protective cultures, which are generally used in an amount from about 0.01 to 0.1% by weight, preferably 0.02 to 0.08, especially 0.025 to 0.05% by weight of the corresponding microorganisms, based on the total weight of the raw meat mass.

The salt used as nitrite pickling salt is generally used in only limited amount, namely from 1.0 to 5.0% by weight, preferably 2.0 to 4.0% by weight, especially 3.0% by weight, based on the raw meat mass and mostly has a preserving effect.

Generally the meat product, preferably sausage, especially a raw sausage, is processed with the Kutter or Wolf grinder.

A meat product produced according to the method of the invention, especially a raw sausage, generally contains from 20 to 30% by weight, especially 24% by weight frozen pork meat S II, 1.0 to 5.0, especially 3.0% by weight freeze-dried meat or as an alternative commercially available soybean isolate, 33 to 42% by weight, preferably 35 to 40% by weight, especially 38% by weight hard frozen bacon or speck and 30 to 40% by weight, preferably 35% by weight fresh pork meat S II. Classification of pork (SI or SII) results from the usual grading according to German guidelines.

Instead of the aforementioned pork classifications, any other meat can naturally be used, like poultry, game, beef or the like in order to be able to offer a taste and/or meat variety adapted to the interests of consumers.

During production of, for example a raw sausage, different methods can be used, namely processing of the meat mass with the Kutter or the Wolf grinder according to the standard conditions.

These standard conditions are three-phase Kutter grinding method at room temperature with a different number of blades and adapted blade speeds.

c) Practical Examples

The invention is further explained below with reference to non-limiting examples. The amounts stated below in g/kg refer to the content of the specifically mentioned substance in g, based on 1 kg of meat/bacon mass.

1) Production of ripening mixture 1:

5.0 g/kg commercially available sodium diphosphate 117779 as stabilizer, 2.5 g/kg Colorant intensiv as colorant, 1.0 g/kg edible salt are mixed together dry in order to produce a total amount of 8.5 g/kg raw meat mass.

The ripening mixture is used without further processing or addition of preservatives for producing a meat product, especially a raw sausage.

2) Production of ripening mixture 2:

Commercially available ground black pepper in an amount of 3.7 g/kg, 18.0 g/kg minor hot mustard flour and 3.0 g/kg licorice root are dry mixed together with a flavoring, namely 0.3 g/kg commercially available chorizo flavoring powder 315487, and 5.0 g/kg thickener, especially thickener RMP 650 alginate 115841, under normal room conditions in order to produce a total of 30.0 g/kg of ripening mixture 2.

The ripening mixture is used without further processing or addition of preservatives for producing a meat product, especially a raw sausage.

3) Production of a meat product, especially a raw sausage with the Kutter grinder:

30 g/kg freeze-dried meat (beef, pork, game or poultry) or 30 g/kg soybean granulate (for example, commercially available from Solae Co. under the name Response®) are placed in the Kutter grinder and finely grounded at fast speed at about 5800 rpm. After about 1 minute, frozen pork S II (as an alternative, other meat varieties, like beef, game, poultry) are added in an amount of 165 g/kg, 8.5 g/kg of the ripening mixture produced according to example 1, 2.5 g PRIMAL® Protek K 101478, 2.5 g Brat Stabil® are added and ground to fineness at room temperature at a fast speed of about 5800 rpm.

After about 3 minutes, 418 g/kg hard frozen bacon or speck is then added along with 30.0 g/kg ripening mixture 2, AROMIX® garlic 333045 is sprinkled in according to the desired taste and grinding with the Kutter ginder continued to the desired grain size (about 1 to 3 mm).

After the desired bacon grain size is reached, 385 g/kg fresh pork meat S II is introduced at slow speed and ground to the end at slow speed (about 1200 rpm) together with 13.0 g/kg commercially available PRIMAL® Rapid 103611 as acidifying agent and 30 g/kg nitrite pickling salt with preservatives to complete distribution. The Kutter grinding time, however, must not last too long after addition of the salt.

The raw meat mass is then immediately introduced in commercially available steam- impermeable sausage casings.

4) Production of a meat product, especially a raw sausage with the Wolf grinder:

All the raw materials described under 3 are homogeneously mixed in a mixer and ground with the 3 mm disk of the Wolf meat grinder.

The raw meat mass is then immediately introduced in commercially available steam- impermeable sausage casings.

5) Reddening or reaction phase:

The raw meat masses processed according to examples 3 and 4 are processed in the fermentation or cooking chamber over a period of 6 hours at 32° C. and 100% relative humidity, thereafter 8 hours at 28° C. at 65% relative humidity and subsequently at 0° C. to 2° C. the raw meat mass filled into steam-impermeable sausage casings is cooled to a core temperature of 4° C., which usually takes place within a period of 12 hours.

The meat product so produced, especially raw sausage, has the following properties within a maximum of 48 hours:
a_{w} values of less than 0.95,
pH values of about 4.8 to 5.0,
a firm consistency,
an aromatic raw sausage taste profile,
no weight loss and
immediate sellability.

Advantageously, no climatic and ripening chambers are required during production of the meat product produced according to the invention, which is particularly preferable for energy reasons.

Inventive benefit:

Drying accompanied by weight loss is no longer connected with the method according to the invention.

1.-6. (canceled)

7. A method for production of meat products from a raw meat mass comprising:
a. adding a ripening accelerating mixture consisting of stabilizers, colorants and/or edible salt (ripening mixture 1) to the raw meat mass; and
b. adding a ripening accelerating mixture consisting of spices, flavorings, and thickeners (ripening mixture 2) to the raw meat mass, wherein the ripening mixture 1 and the ripening mixture 2 are added simultaneously or subsequently to the raw meat mass.

8. The method of claim 7, wherein the ripening mixture 1 and the ripening mixture 2 are added in an amount from 0.1 to 4.0% by weight, based on the total weight of the raw meat mass.

9. The method of claim 7, further comprising the step of adding spices, acidifying agents, enzymes, nitrite pickling salt and/or microorganisms as starter and/or protective cultures to the raw meat mass as additives.

10. The method of claim 8, further comprising the step of adding spices, acidifying agents, enzymes, nitrite pickling salt and/or microorganisms as starter and/or protective cultures to the raw meat mass as additives.

11. The method according to claim 9, wherein the further additives are added in an amount from 0.05 to 5.0% by weight, based on the total weight of the raw meat mass.

12. The method according to claim 10, wherein the additional additives are added in an amount from 0.05 to 5.0% by weight, based on the total weight of the raw meat mass.

13. The method according to claim 7, wherein the raw meat mass is processed with a Kutter or Wolf grinder.

14. The method according to claim 7, wherein the ripening mixture 1 comprises at least one of sodium diphosphate, Colorant® intensiv, and nitrite pickling salt, and wherein the ripening mixture 2 comprises at least one of ground black pepper, mustard flour, licorice root, chorizo flavoring powder, and RMB 650 alginate 115841.

15. The method according to claim 9, wherein the spice is AROMIX® garlic 333045;
the acidifying agent is PRIMAL® Rapid 103611; the enzyme is transglutaminase; and the microorganisms are selected from the group consisting of lactic acid-forming micrococci and lactobacilli.

16. A meat product produced according to the method of claim 7.

17. A method for production of a sausage meat product from a raw meat mass comprising:
a. adding a ripening accelerating mixture that accelerates consisting stabilizers, colorants and/or edible salt (ripening mixture 1) to the raw meat mass; and
b. adding a ripening accelerating mixture consisting of spices, flavorings, and/or thickeners (ripening mixture 2) to the raw meat mass.

18. The method of claim 17, wherein ripening mixture 1 and the ripening mixture 2 are added in an amount from 0.1 to 4.0% by weight, based on the total weight of the raw meat mass.

19. The method of claim 17, further comprising the step of adding spices, acidifying agents, enzymes, nitrite pickling salt and/or microorganisms as starter and/or protective cultures to the raw meat mass as additives.

20. The method of claim 18, further comprising the step of adding spices, acidifying agents, enzymes, nitrite pickling salt and/or microorganisms as starter and/or protective cultures to the raw meat mass as additives.

21. The method according to claim 19, wherein the additional additives are added in an amount from 0.05 to 5.0% by weight, based on the total weight of the raw meat mass.

22. The method according to claim 20, wherein the additional additives are added in an amount from 0.05 to 5.0% by weight, based on the total weight of the raw meat mass.

23. The method according to claim 17, wherein the raw meat mass is processed with a Kutter or Wolf grinder.

24. The method according to claim 17, wherein the ripening mixture 1 comprises at least one of sodium diphosphate, Colorant® intensive, and nitrite pickling salt, and wherein the ripening mixture 2 comprises at least one of ground black pepper, mustard flour, licorice root, chorizo flavoring powder, and RMB 650 alginate 115841.

25. The method according to claim 19, wherein the spice is AROMIX® garlic 333045; the acidifying agent is PRIMAL® Rapid 103611; the enzyme is transglutaminase; and the microorganisms are selected from the group consisting of lactic acid-forming micrococci and lactobacilli.

26. A sausage meat product produced according to the method of claim 17.
